(19) United States
(12) Patent Application Publication
(10) Pub. No.: US 2018/0060998 A1
(43) Pub. Date: Mar. 1, 2018

(54) Techniques and devices for rendering computer graphics objects

(71) Applicant: Salvatore Arcuri, San Ramon, CA (US)

(72) Inventor: Salvatore Arcuri, San Ramon, CA (US)

(21) Appl. No.: 15/249,393

(22) Filed: Aug. 27, 2016

(51) Int. Cl. G06T 1/60; G06T 1/20; G06F 3/06

(52) U.S. Cl. CPC G06T 1/60; G06T 1/20; G06F 3/0673; G06F 3/0658; G06F 3/061

(57) ABSTRACT

This application contains a collection of inventions related to the generation of images using computer graphics. A method to reuse the data contained in FIFOs by restarting the read pointer from a predetermined value. A method for performing the triangle belonging test by using a scanning technique alternating the scanning direction and computing the distance from a group of sampling points to the triangle edge towards which the scanning is moving and to the line from which the scanning is moving from. A method for determining the starting point for rasterization without having to invert the angular coefficient of the line equation, by using window dividers.

### BACKGROUND OF THE INVENTIONS

The background of the invention is that of computer graphics. There are several algorithms, methods and techniques to transform objects described as a group of polygons into pixels that can be loaded into a frame buffer and displayed on the screen.

### Field the Inventions

The field of the inventions is that of digital electronics, computers and computer graphics. In particular, that of computer graphics and of the use of FIFOs and of methods of rasterization of triangles.

### Description of Art Related to Restartable FIFO

In computers, computer graphics, communication devices and in many other fields of digital electronics there is frequently a need to send data through a buffer in a certain order and retrieve it later in a determined order. Based on the order in which data is written and read from the buffer the buffer can be called a stack or first-in-last-out, or a FIFO or first-in-first out.

Stacks and FIFOs can be implemented with shift registers in which data travels through all the stages of the buffer at every clock cycle when data is being written or read, or with memory or register arrays and pointers, in which case data does not move within the buffers but a pointer for write and a pointer for read operations get updated, based on two control signals that we can call respectively write and read or valid and ready or push and pop. The advantage of using memory or registers arrays and pointers instead of shift registers is that since data does not move within the FIFO there is less consumption of power.

The combination of memory or register arrays and pointers and some control signals constituting the FIFOs can be looked as black boxes with some inputs and some outputs.

The inputs are clock, reset, data in, valid and ready. The outputs are data out, empty, full.

Two separate clock signals, one for input clock and one for output clock need to be used if output data is to be used in a clock domain different than the clock domain of the input data. If the two clock signals are the same or if only one clock signal is used, the FIFO is a synchronous FIFO. If two different clock signals are used the FIFO is an asynchronous FIFO.

The signal data in can be a single line of therefore one bit or multiple lines representing multiple bits like in a data bus.

The write pointer increments automatically when a write operation occurs, so that the data will be written into the next sequential location. Similarly the read pointer gets incremented automatically when a read operation occurs, so the data to be output will be read from the next sequential location.

When the reset signal is active both the read and write pointers are set to the same start value, that is a value within the range of valid addresses of the memory or register array with which the FIFO is implemented. Normally the start value of the pointers is zero. In this situation the FIFO is empty and the empty signal is active. If the value of the write pointer increases the empty signal becomes inactive. If the two pointers become equal because the write pointer reaches the value of the read pointer it means that all memory locations have been occupied with data that has not been read yet and thus the full signal becomes active. If the two pointers become equal because the read pointer reaches the value of the write pointer it means that all locations have been read and therefore the FIFO is empty and thus the empty signal becomes active. Although the FIFOs are frequently implemented with memory or register arrays, they can be looked at as pipes through which data flows and once it has come out it is not possible to access that data again within the FIFO.

None of the known implementations of FIFOs describes a mechanism similar to the restartable FIFO that is one of the subjects of this invention.

### Description of Art Related to Rasterization of Triangles

Rasterizing consists of determining the value of the color and other attributes of each pixel within a triangle or a polygon. This involves determining if a pixel belongs to the triangle or not; in some cases determining if other triangles are occluding the view of a particular pixel preventing it to be seen, and computing the color value and other attributes of each pixel.

There is a PhD thesis that describes a rasterizing algorithm broken down into groups.

Ph.D. Thesis by Ali Mohamed Ali Abbas, scientific supervisor Professor Dr. Szirmay-Kalos Laszlo, Faculty of Electrical Engineering and Informatics Budapest University of Technology and Economics, Budapest, 2002.

A statement in this thesis says:

“The idea behind this is to carry out the expensive computations just for a few points or pixels, and the rest can be approximated from these representative points by much simpler expressions using incremental evaluation”

This paper however envisions doing computation for a few elements in hardware and computational of additional increments in software.

In order to reduce aliasing effects caused by sampling the triangle with a spatial frequency much lower than the frequency spectrum of the transition of colors from one side of the edge of the triangle to the other side, supersampling or multisampling techniques are used.

To alleviate the aliasing problem, the method of supersampling performs the sampling of the triangle at higher spatial frequency than the pixel spatial frequency, so that more of the spectrum introduced by sampling will be pushed to higher frequencies and can to be eliminated by filtering.

Since supersampling requires increasing the number of computations by the shader program for each pixel, it is generally avoided in favor of multisampling, a technique where only the triangle belonging test and the occlusion test are performed for multiple subsamples within the pixel and the pixel shader program is run only once per pixel, for the center of the pixel.

### THE INVENTIONS

### Brief Summary of the Inventions

The inventions described in this patent and grouped under the title of Computer graphics rendering techniques consist of the following:

### 1) Restartable FIFOs.

2) Rasterization of triangles: Method and apparatus for performing triangle belonging test. Method and apparatus for performing the triangle belonging test only for the line that is present in the direction in which the triangle is getting scanned. Performing interpolation of attributes of the vertices of a triangle by breaking down the interpolation into a course interpolation and fine interpolation.
3) Method of performing triangle setup by using window dividers.

### BRIEF DESCRIPTION OF THE DRAWINGS

FIG. 1: Top level diagram of a restartable FIFO.

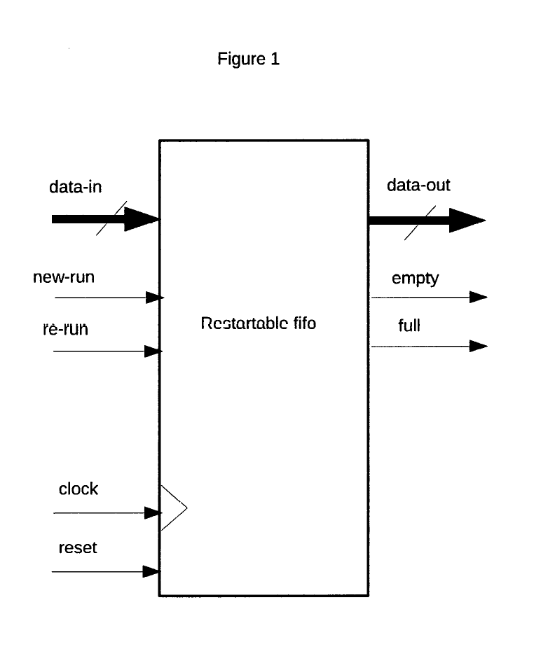

FIG. 2: Internal blocks of a restartable FIFO.

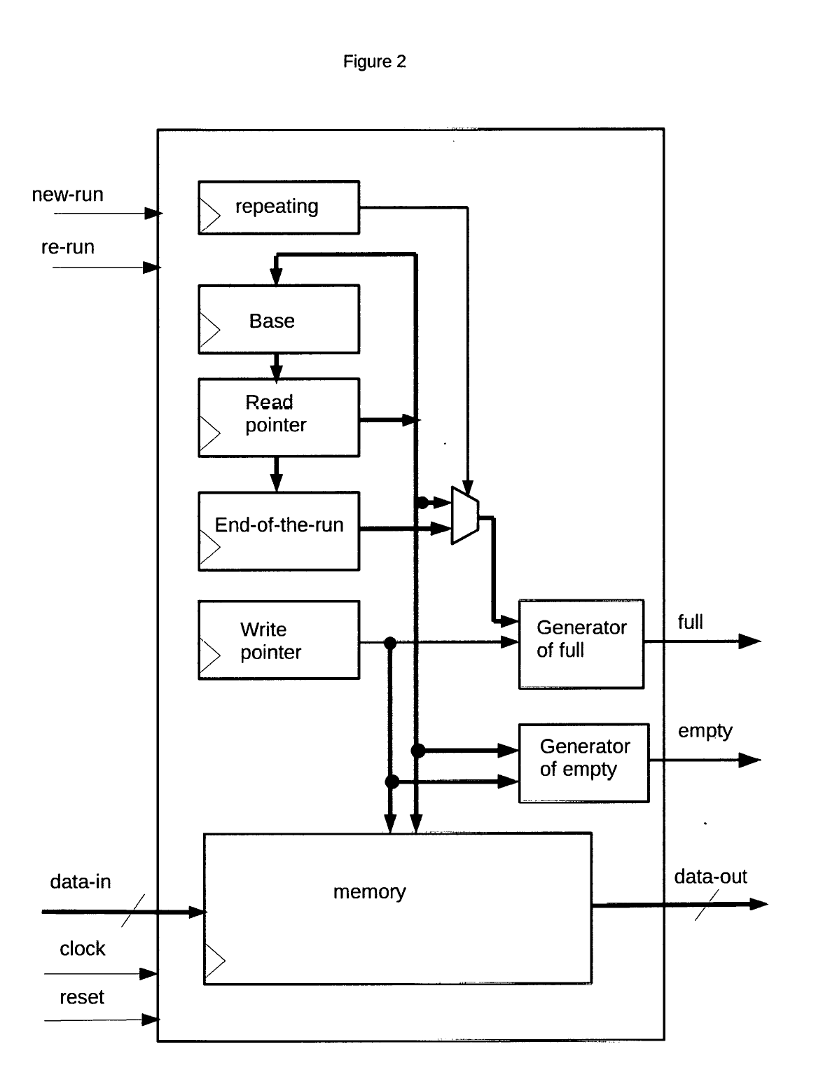

FIG. 3: Illustrates how multiple vertices consisting of multiple attributes can occupy contiguous locations inside a restartable FIFO.

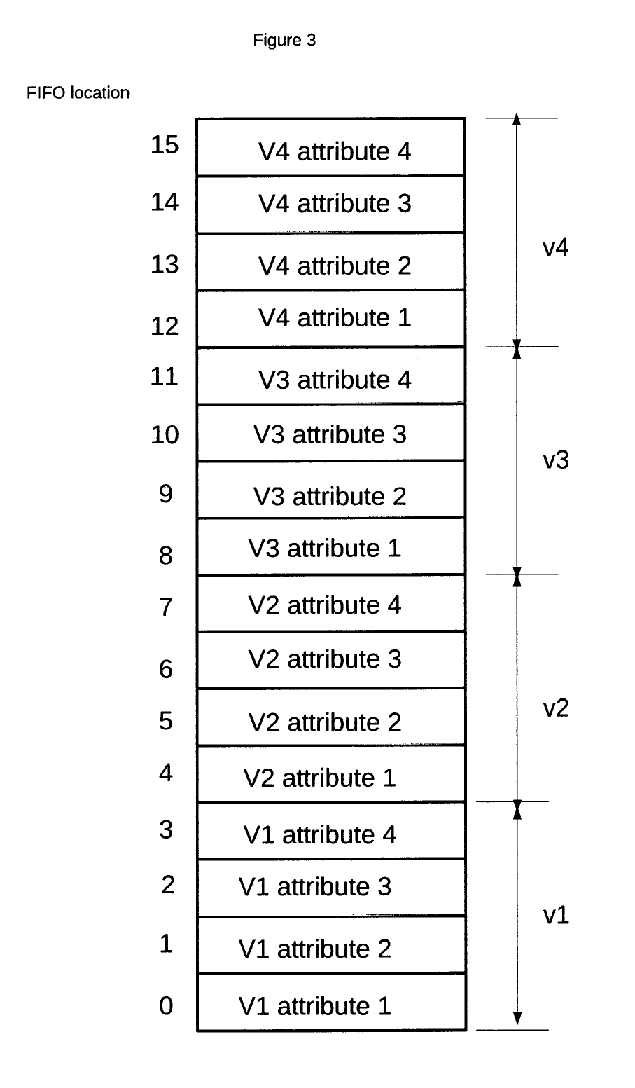

FIG. 4: Illustrates how vertices are shared by two triangles in a triangle strip.

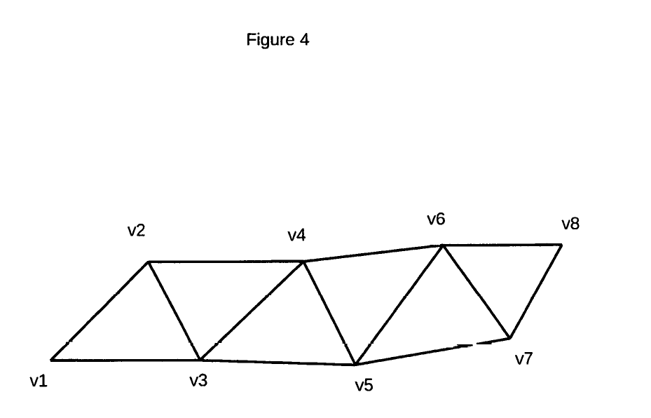

FIG. 5: Illustrates how vertices are shared by multiple triangles in a triangle fan.

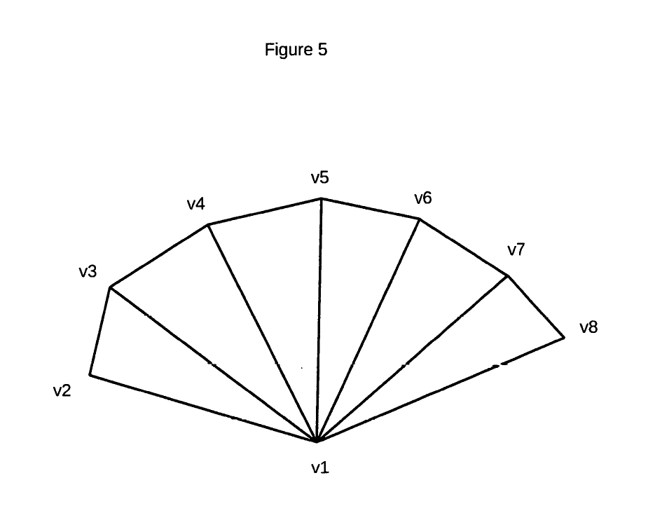

FIG. 6: Illustrates how three restartable FIFOs can be used to assemble triangles.

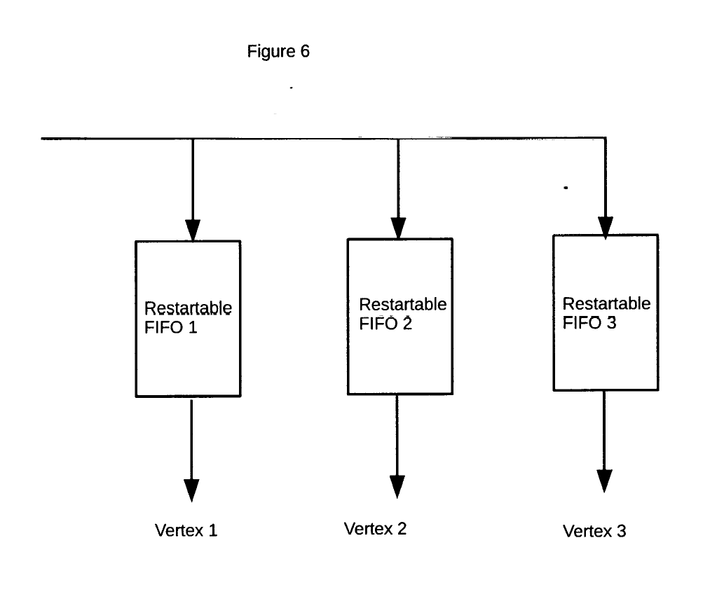

FIG. 7: Illustrates an example of how a triangle with all its vertices outside a horizontal clipping window can fully contain the clipping window.

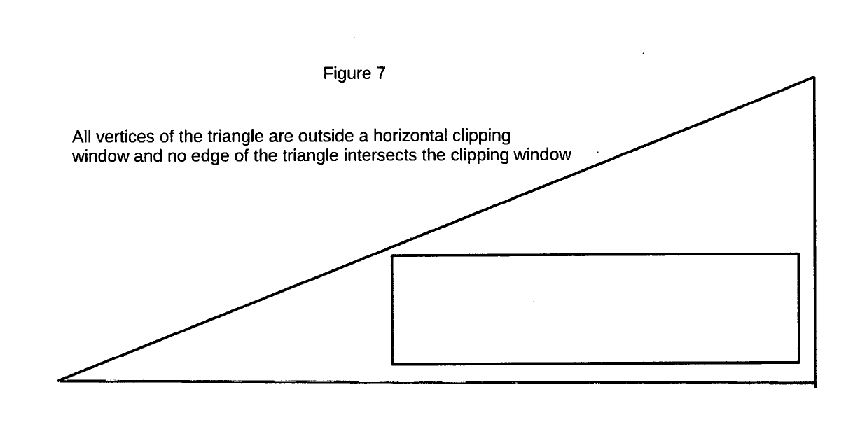

FIG. 8: Illustrates an example of how a triangle with all its vertices outside of a vertical clipping window can fully contain the clipping window.

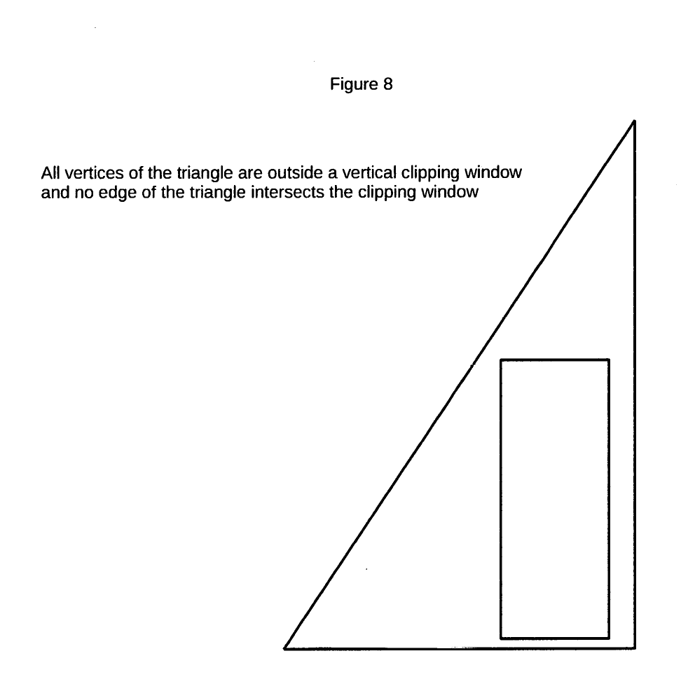

FIG. 9: Illustrates an example of how a triangle with all its vertices outside a horizontal clipping window may intersect the clipping window with two edges.

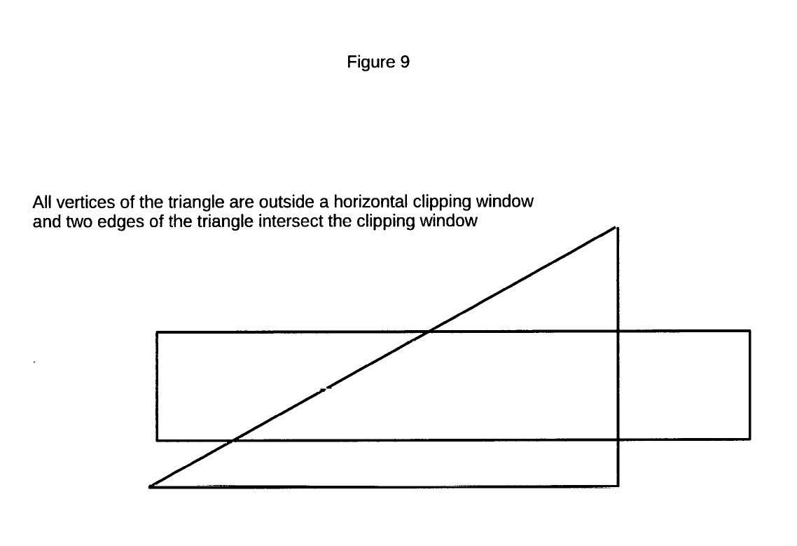

FIG. 10: Illustrates an example of how a triangle with all its vertices outside a vertical clipping window may intersect the clipping window with two edges.

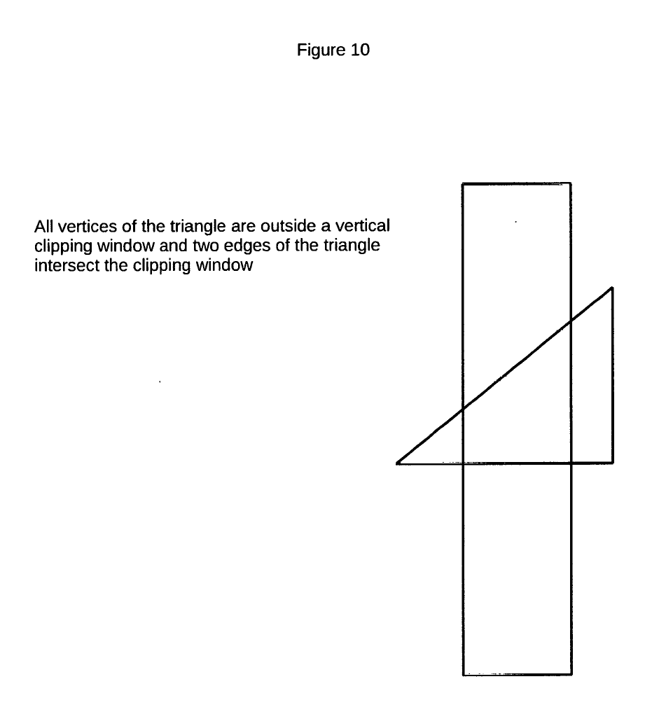

FIG. 11: Illustrates an example of how a triangle with all its vertices outside a horizontal clipping window may intersect a horizontal edge of the clipping window with a single edge and with an incident angle of less than 45°.

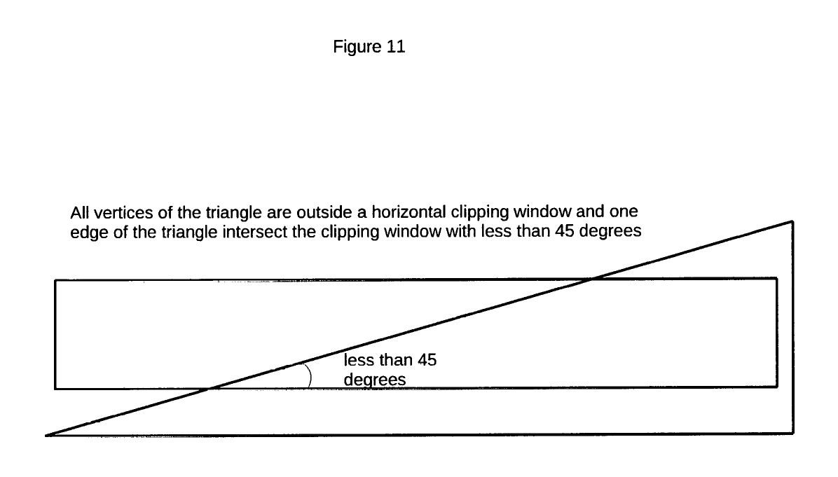

FIG. 12: Illustrates an example of how, in the case of a triangle with all its vertices outside a horizontal clipping window which intersect a horizontal edge of the clipping window with a single edge with an angle whose absolute value is less than 45°, by dividing the window in two halves a new line may be generated, so that the triangle edge will intersect this line with an angle between 45° and 90°.

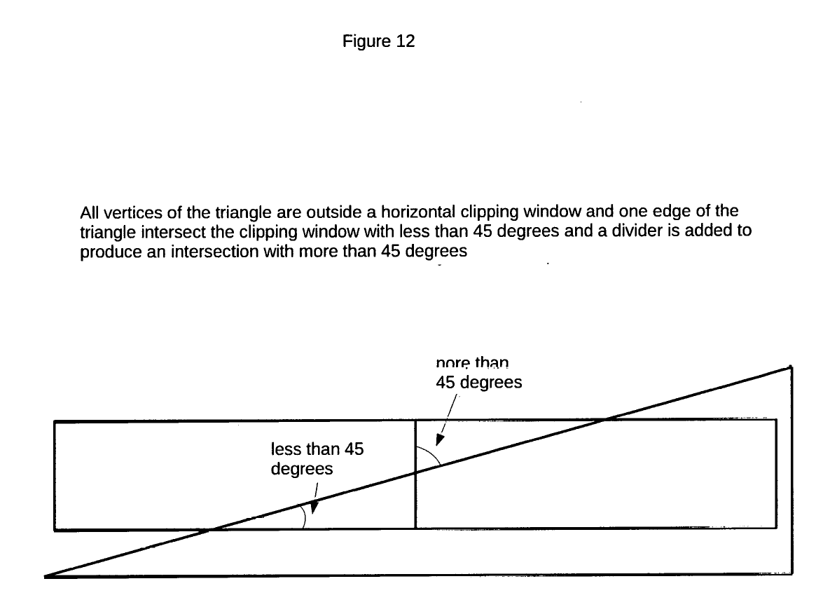

FIG. 13: Illustrates how a triangle that has all the vertices outside of the clipping window may intersect a horizontal clipping window near the end of the window so that a vertical line dividing the window into two parts would not intersect the triangle.

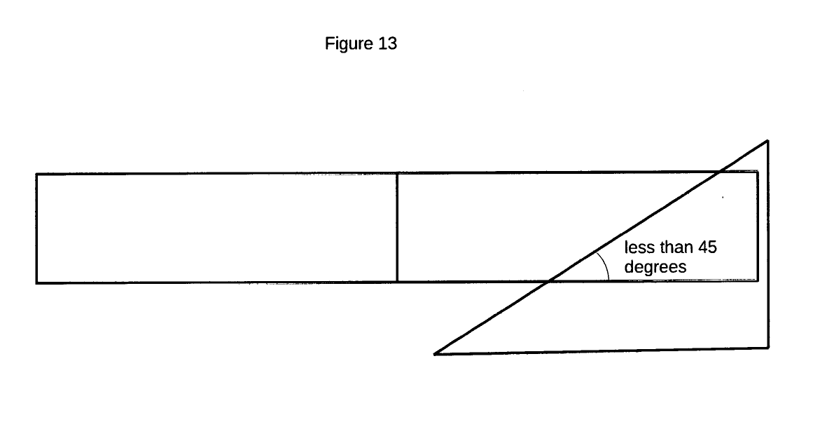

FIG. 14: Illustrates how in the case when the a triangle with all its vertices outside intersects the clipping box near the end of the box and a single divider would not intersect the edge, multiple subdivision of box will generate a line that will intersect the edge of the triangle.

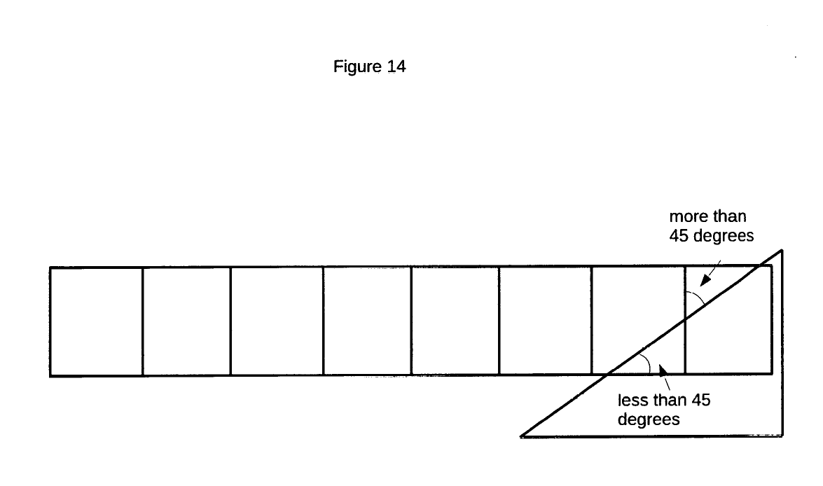

FIG. 15: illustrates the case of a triangle with all its vertices outside of a vertical clipping window with one edge of the triangle intersecting an edge of the clipping box with an incident angle of less that 45°.

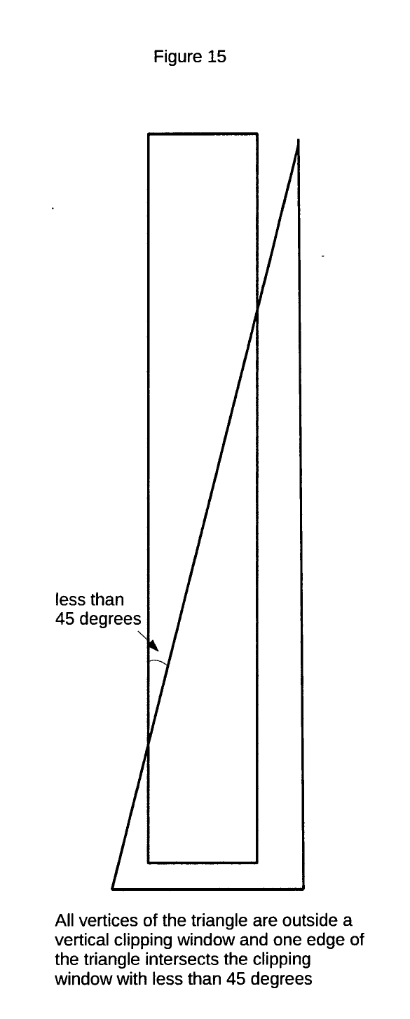

FIG. 16: Illustrates how in the case of a triangle with all its vertices outside of a vertical clipping window with one edge of the triangle intersecting an edge of the clipping window with an incident angle of less that 45°, a horizontal divider which intersects the edge of the triangle with an incident angle between 45° and 90° may be generated.

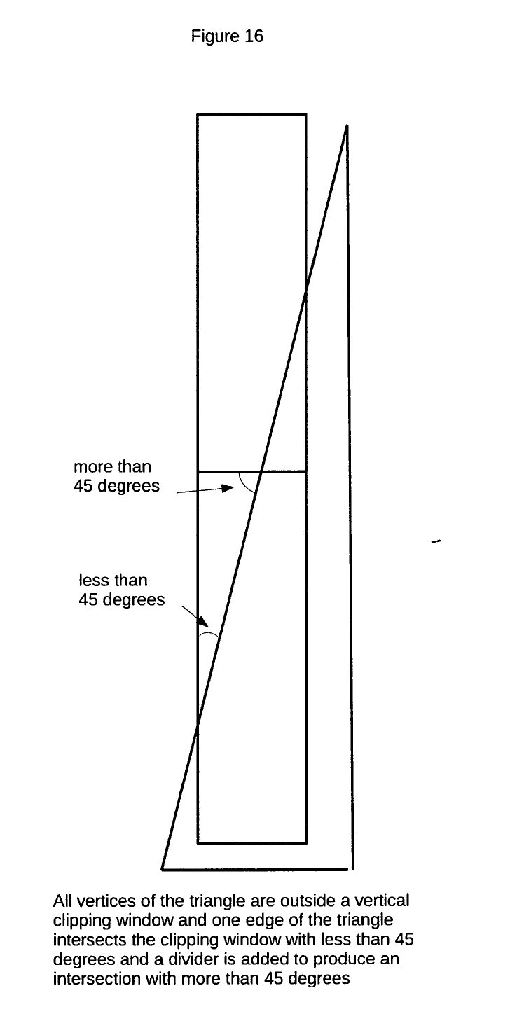

FIG. 17: Illustrates how a triangle belonging test can be accomplished by looking at the three half-planes defined by the three edges of a triangle.

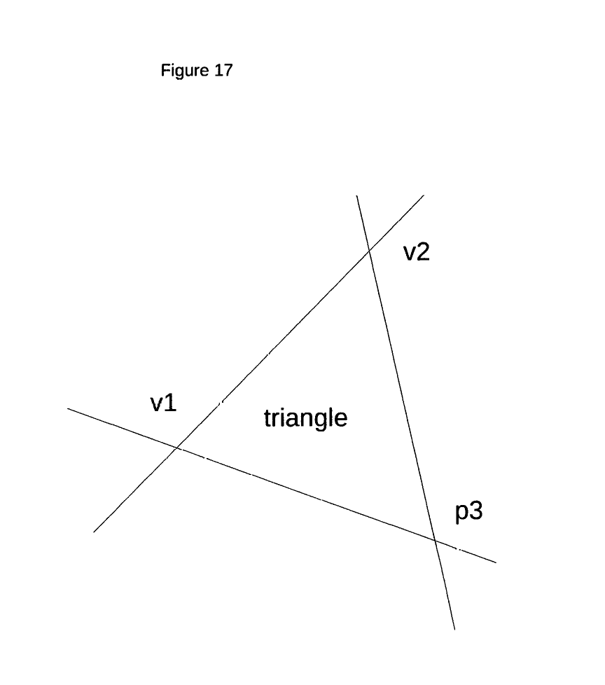

FIG. 18: Illustrates how a triangle can be split into two halves, top half and bottom half, with a line passing the vertex that is at intermediate height, so the triangle belonging test can be accomplished along a horizontal scan line by looking only at the edge that is in the direction of the scan.

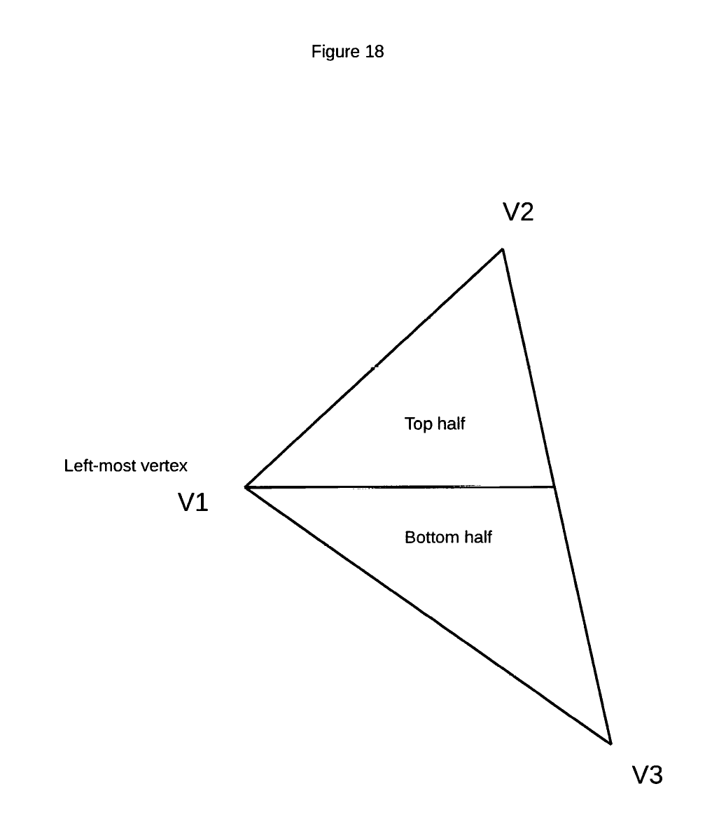

FIG. 19: Illustrates how an alternating scan of a triangle can be accomplished by remaining inside of the triangle most of the time and by looking only at the edge in the direction in which the scan is taking place in order to determine if the triangle boundary is reached.

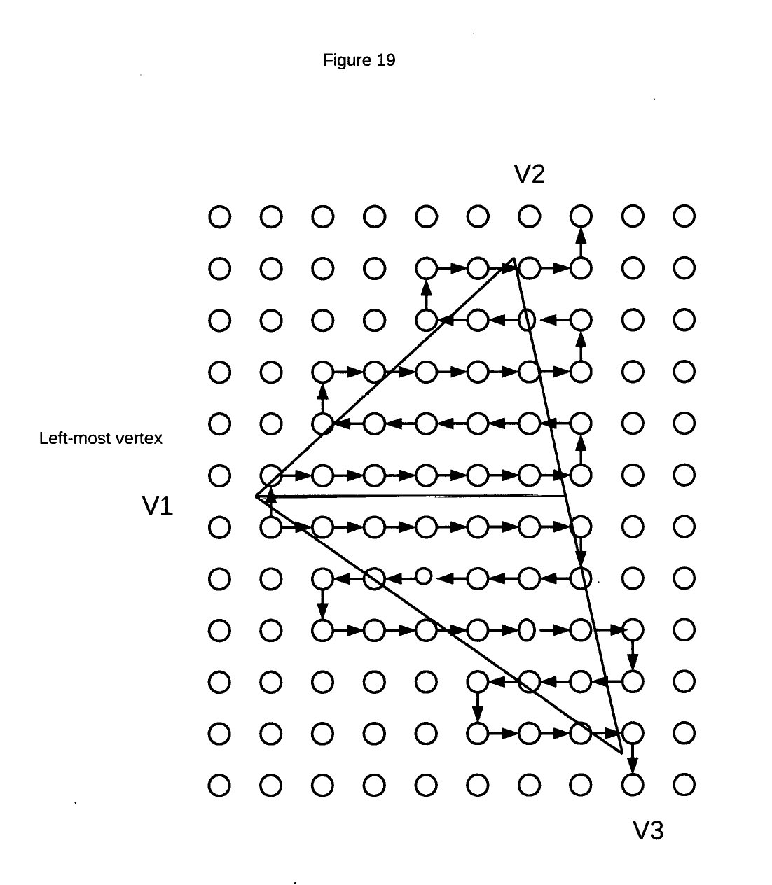

FIG. 20: Illustrates an example of a distribution of four samples within a pixel, over a spatial grid of 4×4 sample locations, in case of supersampling or multisampling, for the purpose of triangle belonging test and for the interpolation of the Z coordinate to be used for occlusion test, and the location at the center of the pixel for the purpose of interpolation of attributes for use in the computations by shader program.

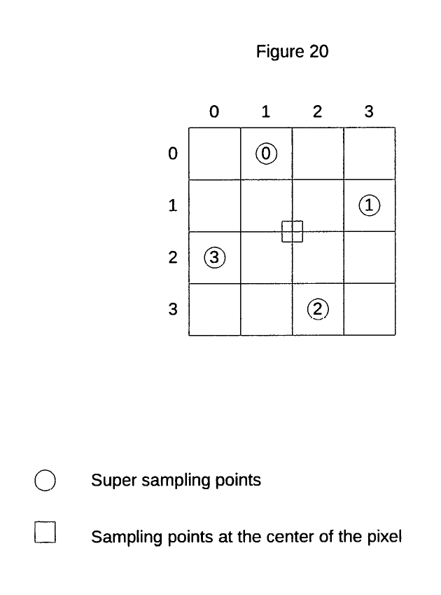

FIG. 21: Illustrates how a group of four pixels can be considered to perform simultaneous triangle belonging test and occlusion test for 16 samples in parallel to increase the fill rate.

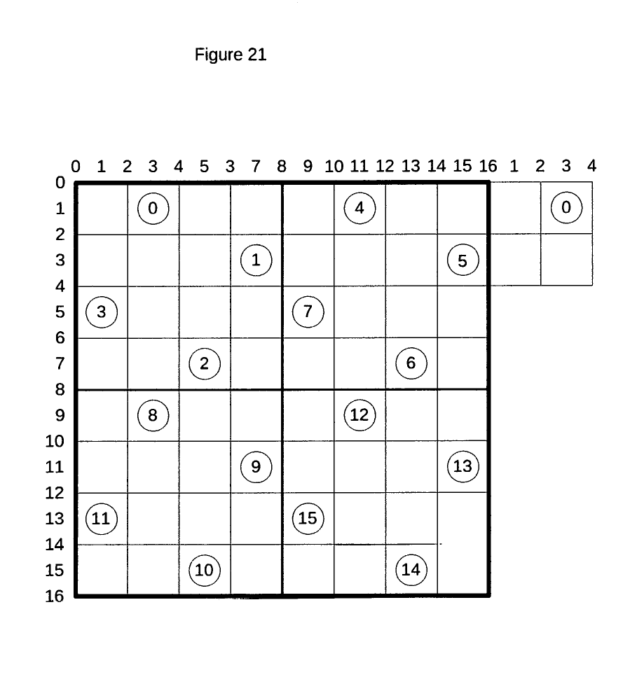

FIG. 22: Illustrates a situation in which the scanning is moving from right to left, the left edge of the half triangle has angle with the x axis with absolute value of more than 45°, the line equation of this edge is in the form of “x=(1/m)*y+k”, and the distance that is being analyzed is the distance along the x direction from the point being analyzed to the left edge of the half triangle.

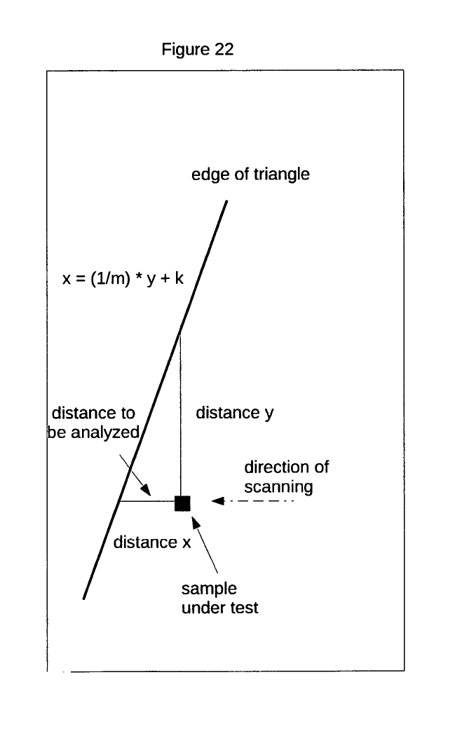

FIG. 23: Illustrates a situation in which the scanning is moving from left to right, the right edge of the half triangle has an angle with the x axis with absolute value of more than 45°, the line equation of this edge is in the form of “x=(1/m)*y+k”, and the distance that is being analyzed is the distance along the x direction from the point being analyzed to the right edge of the half triangle.

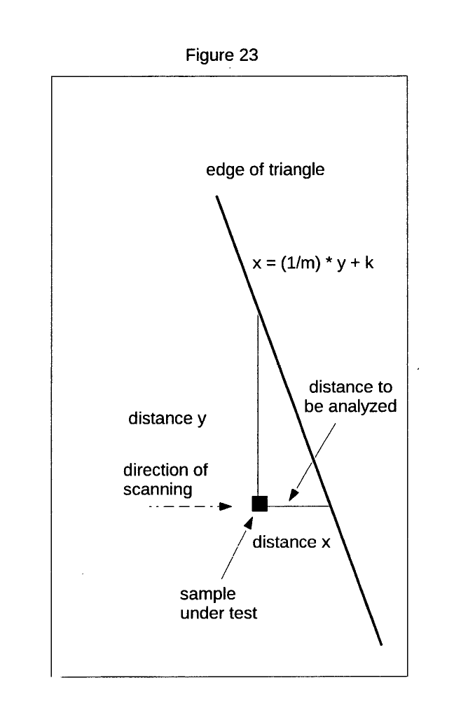

FIG. 24: Illustrates a situation in which the scanning is moving in from right to left, the left edge of the half triangle has angle with the x axis with absolute value of less than 45°, the line equation of this edge is in the form of “y=m*x+c”, and the distance that is being analyzed is the distance along the y direction from the point being analyzed to the left edge of the half triangle.

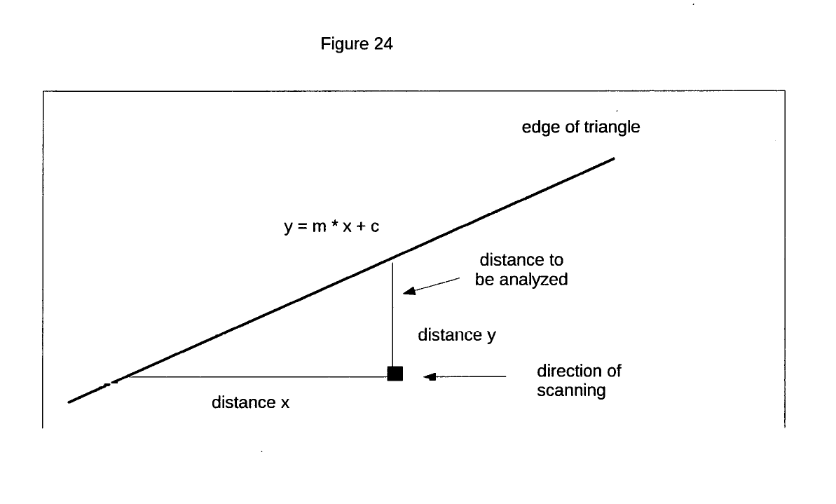

FIG. 25: Illustrates a situation in which the scanning is moving in from left to right, the left edge of the half triangle has angle with the x axis with absolute value of less than 45°, the line equation of this edge is in the form of “y=m*x+c”, and the distance that is being analyzed is the distance along the y direction from the point being analyzed to the right edge of the half triangle.

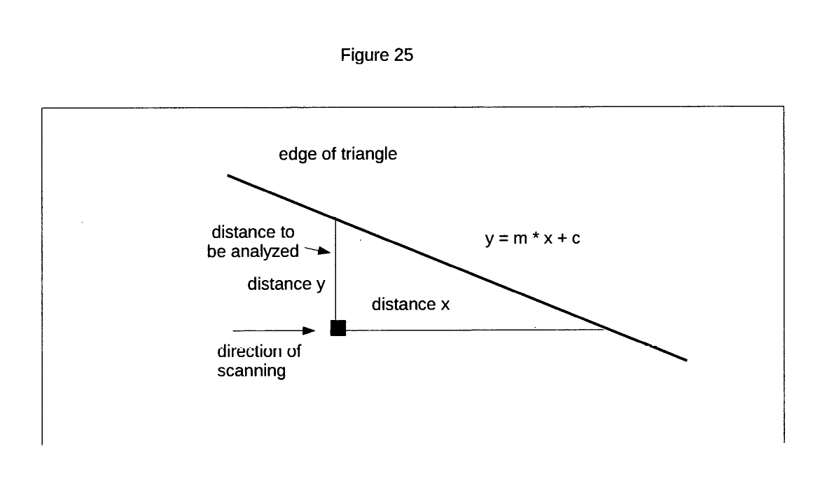

### DETAILED DESCRIPTION OF THE INVENTIONS

### Detailed Description of the Invention “Restartable FIFO”

### Implementation of Restartable FIFO

Some applications, like in computer graphics, may need to reuse data that is in a FIFO multiple times. There are some geometrical entities called primitives which consist of a sequence of vertices. These sequence of vertices define triangles or other objects or sequences of triangles or of other objects. Triangles are assembled from vertices based on rules depending on the primitive type.

In order to reduce the amount of data being transferred or stored between different stages and save bandwidth, storage space and processing power, when a vertex is shared by adjacent triangles, it is possible to use the same vertex multiple times, rather than re-generating it or re-transferring it.

An example of this is when vertices are used to form a primitive called a triangle strip or a triangle fan. When assembling triangles from a triangle strip or a triangle fan vertices that are in common to multiple triangles need to be read multiple times. Data representing vertices consists of a series of attributes, like position, color, vertex, etc. Each attribute may be represented with a digital word of several bits, for instance 16 bits, 32 bits, 64 bits.

Data representing a vertex consists of a packet composed of several attributes, like position, color texture, etc. This data can be placed in a FIFO. The FIFO may be large enough to contain multiple vertices. Each attribute of a vertex may occupy a location in the FIFO.

To construct a triangle from vertices we have three separate FIFO, one for each vertex of the triangle.

If two or more triangles have a vertex in common, that vertex is used multiple times.

In a conventional FIFO data is considered to have exited the FIFO once in has been read from the FIFO. If we used a conventional FIFO to hold the attributes of the vertices, we would have to reload the FIFO with the data of the vertex that has already exited.

To overcome the need to reload the FIFO, this invention presents a method and apparatus consisting a FIFO that allows its data to be readable multiple times starting from a predetermined location in the FIFO. We call this FIFO a restartable fifo.

The restartable FIFO which has two additional control signals which we call “new-run” and “re-run”, and three additional registers which we call “base”, “end-of-the-run” and “repeating”.

The restartable FIFO utilizes the fact that although the read pointer has advanced, data has not physically left the buffer that is the data storage structure of the FIFO. Since data is still there, in order to reuse it we simply need to change the read pointer and start reading again from the beginning of the last packet. To be able to do this we need to know where the beginning of the last packet is.

We use two input signals: new-run, which allows us to capture the read pointer into the base register when we start reading a new packet; re-run, which causes the read pointer to start re-reading from the beginning of the last packet.

Each time the new-run signal is active the value of the read pointer is captured into the base register. When the re-run is active it causes the read pointer to start counting from the value stored in base register.

Since the number of attributes that a vertex contains is predetermined, it is possible to know when a vertex has completely exited the FIFO and when the read pointer is pointing to the beginning of a new vertex by counting the number of attributes that have come out. Another method that allows us to know when a vertex has completely exited the FIFO consists of using a special bit associated with the data item, that indicates that the data item is the last attribute.

When we start reading from a new vertex we activate the signal new-run. This will cause the FIFO to store the value of the read pointer, which is pointing to the location containing the beginning of the vertex, into the base register. In this way, although inside the FIFO there may be several packets representing several vertices, we keep the position of the beginning of the most recent packet that we have read inside the base register.

If a vertex belongs to multiple triangles, after we are done reading that vertex from the restartable FIFO in order to assemble a triangle, we read it again from that same restartable FIFO to assemble another triangle.

The technique of using a restartable FIFOs can be applied in several locations in the 3D graphics processing pipeline. This same technique may also be used in other applications when data contained in the FIFO needs to be used multiple times.

Although the same task can be accomplished by using random access memory and pointers, because data flows in a stream, organizing the flow through a FIFO rather than through some randomly accessible memory provides a convenient way of dealing with the complexity of the design.

The restartable FIFO contains data-out, empty and full output signals;

data-in, valid, ready, new-run, re-run, clock and reset inputs signals

The restartable FIFO internally contains the data buffer and five registers: write pointer, read pointer, base, end-of-the-run, repeating status;

The write pointer and the read pointer are registers that point to the location that is being written and read. The read pointer, write pointer, base and end-of-the-run registers are one bit wider that what is strictly needed to address the buffer, in order to be able to distinguish full and empty conditions.

The repeating status signal is one bit wide.

In a conventional FIFO the determination of full is done by comparing the write pointer and the read pointer, however in a restartable FIFO this could produce wrong results because the read pointer is not necessarily the end of the stream in the FIFO because we could have started to read the same stream again and therefore the end of the stream, which we still would like to preserve and detect if the write pointer reaches to it, may be beyond the current value of the read pointer. Therefore we need to keep another value stored in a different register, to compare with the write pointer. We call this value the end-of-the-run.

Since some times we are reading new data and some times we are re-reading the already read data we need to know when we are reading new data and when we are re-reading already read data because in order to determine when the FIFO is full in the first case we need to compare the write pointer with the read pointer and in the second case we need to compare the write pointer with the end-of-the-run. For this purpose we have a status bit that we call “repeating”.

The generation of empty is obtained by comparing the write pointer with the read pointer.

The generation of full is obtained by comparing the write pointer with the read pointer during normal operation and by comparing the write pointer with the end-of-the-run register during the repeating state.

The status bit repeating is set by activating the input signal re-run and it gets cleared when the read pointer reaches the end-of-the-run.

The register “base” is used to capture the value of the read-pointer when we want to identify the beginning of a new section, by activating the signal new-run.

When we activate the input signal new-run the value of the read-pointer gets copied to the base register.

When we activate the input signal re-run: the value of the read-pointer gets copied to the end-of-the-run register, the value of the base register gets copied onto the read pointer, the repeating status signal gets set.

The repeating status signal gets cleared when the read pointer reaches the value of the end-of-the-run register.

In summary, the restartable FIFO contains five storage structures: the data buffer, the read pointer, the write pointer, the base register, the end-of-the-run register and the repeating status register.

The write pointer gets incremented as a conventional FIFO every time the “valid” signal is active and the FIFO is not full.

The read pointer, if the re-run signal is active gets loaded with the value of the base register, and if the re-run signal is inactive it gets incremented every time the “ready” signal is active and the FIFO is not empty,

Re-reading the most recently read packet from a restartable FIFO, like a conventional FIFO, does not affect the remaining data is inside the FIFO.

### Inventions Related to the Use of Restartable FIFO

The use of the restartable FIFOs enabled three other inventions:

1) Triangle assembly block using restartable FFOs to hold the value of vertices of a triangle that are shared among multiple triangle.
2) Triangle clipping block using restartable FIFOs to generate interpolated values of triangle attributes along edges of the triangle sharing the same vertex.
3) Triangle rasterizer using restartable FIFOs. Computation of pixel attributes at each pixel of a triangle, using the precomputed value for parameters that are common for the whole triangle and that need to be reutilized for every pixel.

Although several applications of this invention are in the field of computer graphics, this invention represents a general technique that can be used in applications when data contained in the FIFOs needs to be utilized multiple times.

### Use of Restartable FIFOs to Implement Triangle Assembly Logic

This invention consists of implementing triangle assembly logic by using three restartable FIFOs. One for each of the three vertices of the triangle. Although each FIFO may contain data representing multiple vertices, the most recent vertex read from a particular FIFO can be read multiple times without affecting the other vertices contained in the FIFO. This makes it possible to reutilize some vertices when assembling multiple triangles which have vertices in common.

### Use of Restartable FIFOs to Implement Triangle Clipping Logic

This invention consists of implementing triangle edge interpolation for clipping using restartable FIFOs.

When generating new triangles as a result of clipping, interpolating is required. If a vertex is used to interpolate along two edges of a triangle that vertex may be re-read from a restartable FIFO twice. Once for each edge along which the interpolation is being done.

### Use of Restartable FIFOs to Implement Triangle Rasterizer Logic

This invention consists of using restartable FIFOs to generate pixel data during rasterization. Some geometric properties of the triangle, like derivatives of the attribute in the x and y direction, value of attributes of a starting point, or other, are utilized by all the pixels inside the triangle. These properties can be contained in restartable FIFOs. The FIFOs may contain properties of multiple triangles. The properties of the oldest triangle can be retrieved multiple times from the restartable FIFOs and utilized for multiple pixels.

### Use of Restartable FIFOs to Read the Depth Buffer Cache

This invention consists in utilizing a restartable FIFO to re-issue the address of the depth buffer location to the depth buffer cache in case of a depth buffer cache miss. Pixel or sample coordinates coordinates generated by the rasterizer are converted to addresses for the depth buffer. In case there is a cache miss the data provided by the cache needs to be invalidated. Invalidation of the data requires that the same address be reissued after a cache miss. Since the address is not produced by a linear counter but an x counter that wraps around and by a y counter, it is not possible to decrement a single counter to repeat the address that was invalidated due to the cache miss. Instead, a procedure that allows easily repetition of the invalidated address is to place the addresses resulting from the conversion of the x and y counters into a restartable FIFO. The new-run pointer of the FIFO gets updated at every cache request, and if the a stall is generated by the cache, at the end of the stall the re-run signal is activated, so the FIFO will repeat outputting the addresses starting from the address that was invalidated.

### Detailed Description of Rasterization of Triangles

### Discovery of the Starting Point Using Windows Dividers

Scenes are composed of many triangles. Due to physical limitations the visible triangles are limited to the triangles that are within a viewing window, called the clipping window. The process of transforming triangles described by its vertices and attributes at the vertices into pixels with a certain color is called rasterization.

A desirable feature of a rasterizing algorithm is that the algorithm should be able to perform well for small triangles and for large triangles. Certain operations are required for every pixel within the triangle, whereas some other operations are required only once for the triangle, and their results get utilized when computing the attributes of each pixel of the triangle. The operations that are performed once per triangle are called triangle setup operations. Scenes that contain many triangles, require performing many setup operations. In scenes that contain many triangles the performance of the graphics processor is limited by the number of triangles that the processor can process per second. Scenes that contain few triangles require performing few setup operations. However, although some scenes may have few triangles, those triangles may be large and therefore there will be a large number of pixels to be processed for each triangle. In that case the limiting factor for the performance of a graphics processor is not the capability of processing a certain number of triangles per second, but the capability of processing a certain number of pixels per second, or the fill rate.

A common triangle rendering algorithm consists of surrounding the triangle by a bounding box, which is the intersection of the smallest box that contains the triangle and the clipping window, and analyzing all the pixels within the bounding box to determine whether they are inside of the triangle or outside of the triangle. However, since the triangles can have any shape, there may be some triangles that are very thin and in an oblique orientation. Large triangles, and specially long and oblique triangles have the problem of generating a lot of empty space in the bounding box. Even the best oriented triangle will leave half of the bounding box empty.

These triangles cause the bounding box to have a large area which is not used by the triangle. Therefore much computational effort would be wasted analyzing pixels that are outside the triangle and which would have to be rejected. It would be better if one could reject the areas that are outside the triangles without having to analyze them.

Another algorithm for rasterizing triangles is that of computing the start and end point of scan lines bounded by two edges of the triangle. This requires more computations for each triangle and fewer computations per pixel.

Computations of scenes with large number of triangles are limited by the number of triangles per second that the graphics processor can process. Computations of scenes with large triangles are limited by the triangle fill rate.

If one tries to improve the performance for large triangles, by improving the fill rate by using a scan line algorithm, is required to use an expensive setup algorithm which damages the performance of number of triangles per second when there is a large number of small triangles.

To summarize: The bounding box algorithm allows the processor to process a large number of triangles per second it but it has a poor performance for the triangle fill rate.

In order to increase the fill rate it is desirable to avoid processing pixels in the bounding box that do not belong to the triangle.

A scan line algorithm is more desirable in order to achieve a good fill rate. A scan line algorithm however requires expensive setup operations which damage the performance in the case the limitation is represented by a large number of small triangles.

These conflicts present the need for an algorithm that allows processing large number of triangles per second during setup and large number of pixels during rasterization.

This invention consists of an algorithm that allows to perform scan line rasterization algorithm while using a fast setup algorithm and therefore provides good performance for large number of triangles per second and large number of pixels per second.

The scan line algorithm that we implement requires knowing a starting point of the triangle that is part of the window. Once we know the starting point we move incrementally horizontally and vertically in a zig-zag fashion making sure that we are always inside the triangle, and if an increment causes us to exit the triangle we re-enter the triangle as soon as we detect that we exited from it. This avoids looking at large areas outside the triangle. The knowledge of the starting point is essential.

If at least one vertex of the triangle is within the clipping window the starting point can be one of those vertices. If all the vertices of the triangle are outside of the clipping window there are two possible scenarios: One is that the triangle fully contains the clipping window; the other is that at least one of the edges of the triangle intersects the clipping window.

In the first case a corner of the clipping window can be used as a starting point. In the second case we can to find a starting point as the intersection of that edge with one of the edges of the clipping window. Computing the intersection requires an interpolation of the edges of the clipping box with the line. This requires the line equation.

When we compute the line equation, we want to make sure that we do not have a coefficient of infinity and we want to avoid having to divide by zero. If the angle that the line forms with the x axis is less than 45° we compute m, which in this case can vary between 0 and 1, and we use the equation “y=m*x+c”. If the angle is greater that 45° we compute 1/m, which in this case can also vary between 0 and 1, and we use the equation “x=(1/m)*y+k”.

For each line we compute either m or 1/m.

If the absolute value of the angle that the line forms with the x axis is less than or equal to 45° we use the equation “y=m*x+c” and for this line it is easy to find the intersection with a vertical edge of the clipping box since we can just substitute the value of the x coordinate of that edge in the equation without the need to invert m.

If the absolute value of the angle that the line forms the y axis is less than 45° we use the equation “x=(1/m)*y+k” and for this line it is easy to find the intersection with a horizontal edge of the clipping box since we can just substitute the value of the y coordinate of that edge in the equation without the need to invert 1/m.

If the line intersects a vertical edge we would like it to have an angle respect to the x axis of less than or equal to 45° so we could use the equation “y=m*x+c” and if it intersects the horizontal edge we would like to have an angle respect to the x axis of greater that 45° so we could use the equation “x=(1/m)*y+k”.

However there is no guarantee that a line that intersects a vertical edge has an angle with absolute value of less than or equal to 45° with respect to the x axis, or a line that intersects a horizontal edge with an angle with absolute value greater than 45° with the x axis.

Since the line is given we cannot change the inclination of the line, but we can change the edge against which we compute the intersection. If the line does not intersect that edge that we choose, we generate a new edge by subdividing the clipping box.

If the line has an angle on less than or equal to 45° with the horizontal axis and it does not intersect a vertical edge of the box we add vertical subdivisions in the clipping box until a vertical subdivision intersects the line.

If a line has an angle of more that 45″ with the horizontal axis and does not intersect a horizontal edge we add horizontal subdivisions in the clipping box until a horizontal subdivision intersects the line.

In this way we solve the problem of finding a starting point without having to compute the reciprocal of m or of 1/m.

Instead of computing the reciprocal we divide the clipping window into multiple windows, until the orientation of the new windows becomes different than the orientation of the original window.

For instance, if the window was horizontal, more wide that tall, we divide the window into two smaller and narrower equal windows of the same height, then each of the sub windows into two more and so on, until the newly generated windows will be vertical, more tall than wide. If the clipping window is vertical we divide it into two shorter windows of the same width, repeating the process until the newly generated windows will be more wide that tall.

In this way we will always be able to compute the intersection of the line with a window edge or a window divider using the line equation that we have, without having to compute the reciprocal of m or of 1/m. We will be able to find a starting point within the clipping window using the equation that we have for that line, regardless of whether the line equation is in the form “y=m*x+c” or in the form “x=(1/m)*y+k”.

In summary, if the clipping window is thin and all the vertices of the triangle are outside of the clipping window and an edge of the triangle crosses the clipping window, we add one or more vertical lines to the window if the window is wider than taller, or one or more horizontal lines if the window is taller than wider, which act as dividers, so that there will always be an edge of the clipping window or a divider of the clipping window for which the computation of the intersection with the edge of the triangle can be accomplished using the line equation that we have, without the need to compute the reciprocal of m or the reciprocal of 1/m.

The subdivision enables us to avoid inverting the coefficients m or 1/m. An alternative is to compute the reciprocal of m or 1/m.

Only triangles that do not have at least a vertex inside the clipping window would have to undergo this operation. Statistically only a small percentage of the triangles would have this characteristics. For most triangles the starting point can be found without the need of this subdivision or computation of the reciprocal.

Because of this, neither the use of subdivisions nor the use of a reciprocator nor the use of a multiplier and a sequencer to implement Newton Raphson's algorithm for computing the reciprocal would impact the performance much.

The benefit of the subdivisions allows us to save the reciprocal but it has small impact on performance.

### Rendering by Alternating Scanning Algorithm and by Coarse Spatial Resolution and Fine Spatial Resolution

The main benefit of this invention is a zig-zag rasterizing algorithm. This algorithm allows us to perform rasterization by starting from a pixel that belongs to the triangle and scanning the triangle by staying inside it most of the time and by reentering in the triangle as soon as we get out, avoiding to analyze large areas outside of the triangle, while having a setup algorithm that can be implemented fast for most triangles.

This invention makes it possible to achieve a high fill rate and keep small the amount of processing that needs to be performed in the setup phase. It splits the triangle in two halves and scans each half in a zig-zag way.

This method works well for small triangles and for large triangles. It requires that we know a staring point that is inside the triangle. Then we move inside the triangle, searching one neighboring pixel after the next until the whole triangle is searched. In this way we do not process pixels that are outside the triangle, except those immediately outside it, which allow us to discover that we crossed the triangle boundary and therefore we need to change the direction of the search.

Rasterization has these two major functions:

1) Belonging test to determine if the pixel is inside the triangle or not.
2) Computation of 1/w and of the other attributes at a particular pixel location, through interpolation from the values of these attributes at the vertices of the triangle.

In the preferred implementation in order to support multisampling each pixel contains 4 samples, distributed on a grid of 4×4 locations within the pixel. Of the 16 locations only 4 locations contain valid samples.

In order to increase the fill rate, rather than one pixel at a time this invention allows the processing of several pixels at a time. Several pixels or subpixel samples can be processed together in a group o N×N pixels or subpixels, where N is an arbitrary number. In the preferred implementation 4 pixels, each consisting of 4 subsamples are grouped together in a 4×4 samples array and processed simultaneously.

The use of a pixel block, consisting of the grouping of several pixels or subpixels to be processed simultaneously, can be applied to the phase of triangle belonging test and to the phase of the attribute interpolation.

### Triangle Belonging Test

Rather than performing the belonging test against the three edges of a triangle it is possible to perform the belonging test against only one edge of the triangle, by scanning along the horizontal direction or along the vertical direction. In a preferred embodiment the scanning would be along the horizontal direction.

Scanning can be achieved in a way an amoeba moves. When it touches a boundary it changes direction. We call this an amoeba algorithm. We break the triangle into two halves, lower half and upper half, separated by the horizontal line that contains the leftmost point. We start rendering the lower half starting from the left-most point, where the values of the attributes are known, and we compute the location at neighboring positions. At each new position we determine if the pixel is inside the triangle or not, and if it is inside we compute the value of the attributes at that position. If it is not inside the triangle we ignore that pixel. When we find that we have reached an edge of the triangle we move down to the adjacent row and we reverse the scanning direction. To determine whether we have reached the edge or not we look only at the edge of the triangle that is in the front of the direction of scanning. The setup block provides the distance of the starting point from all the three edges of the triangle, to the rasterizer. The rasterizer selects two edges of the half triangle to be one the starting line end one the ending line.

During the scanning process we move from the starting point to a new pixel which may be several pixels distant, in the direction of scanning and at every iteration we compute the distance of this new point from the starting line and the ending line.

When we scan from left to right we increment the distance from the pixel or sample being considered to the left line and we decrement the distance from the pixel or sample being considered to the right line and we look at the right line to see if we have exited the triangle.

When we scan from right to left we decrement the distance from the pixel or sample being considered to the left line and we increment the distance from the pixel or sample being considered to the right line and we look at the left line to see if we have exited the triangle.

Rather than performing the belonging test against all edges of the triangle we perform the belonging test only against the line that we expect to encounter in the direction in which scanning is progressing.

If we have reached the bottom of the triangle we repeat the same process for the upper part of the triangle, moving up one row each time we switch direction, until we determine that we have reached the end of the triangle.

Alternatively we could have processed the upper half first and the lower part later and we could have started from the right-most pixel rather than the left-most pixel. We also could have split the triangle vertically rather horizontally and done the scanning vertically rather than horizontally, with similar considerations.

Although we are scanning along the x direction, for the belonging test we can use either the x or the y coordinate. This is convenient because we can use either the coefficient m of the line equation or the coefficient 1/m, whichever we already have available for that particular line and we do not need to perform another division to produce a coefficient that we do not have.

The distance from a particular point to the edge of the triangle towards which we are moving during the scan process can be broken down into two components. A vertical component and a horizontal component. Both of these components will change sign when we cross the edge of the triangle.

The decision of whether we have crossed the triangle boundary or not can be made by analyzing either one of these two components. However depending on the inclination of the line the line equation is in the form “y=m*x+c” or “x=(1/m)*y+k, making in one case easy to compute the y component of the distance and in the other case the x component of the distance.

If the equation of the edge of the triangle is in the form “y=m*x+c”, the y component of distance from the starting point to this edge can be computed by simply substituting the x coordinate of the starting point in the line equation.

If the equation of the edge of the triangle is in the form “x=(1/m)*y+k”, the x component of distance from the starting point to this edge can be computed by simply substituting the y coordinate of the starting point in the line equation.

Therefore if the edge of the triangle forms an angle in absolute value of equal or less than 45° with respect to the x axis, we look at the y component of the distance, and at every step we subtract or add the increment of the y component of the distance. The increment Δy can be simply computed as Δy=m*Δx and if Δx is 1 then the increment Δy is simply m.

If the edge of the triangle instead forms an angle with absolute value greater than 45° with respect to the x axis we look at the x component of the distance, and at every step we subtract the increment in the x direction Δx which is 1 in the case in which we process one pixel at time or a number n in the case when we process a group of n×n pixels at time.

During rasterization we use the integral method and a course resolution determined by the boundaries of these blocks, and the incremental method and fine resolution for the samples within the blocks.

When we perform the triangle belonging test we analyze the distance of all the samples from the edge of the triangle towards which scanning is moving, and at every step we compute the distance of the current pixel or sample from two edges of the triangle, from the one towards which we are going and to the one from which we are leaving.

Depending on the inclination of the triangle edge towards which scanning is moving the determination of whether we have crossed the triangle edge or not can be done by analyzing one or more samples within the block that are closest to that triangle edge or all the samples in the block.

### Interpolation of the z Attribute

Each vertex may contain several attributes. Essential ones are position and color attributes. Other attributes are texture information, normals, etc.

The position attributes are x, y, z, w. The color attributes are r, g, b, a.

After the belonging test is performed the value of the attributes need to be computed.

The x and y attributes are used as independent variables pointing to a particular pixel or sample, dependent on which the other attributes are computed. The z attribute, which is required to perform the occlusion test, is computed at every sample location. The remaining attributes are computed only at the center of the pixels.

Computation of these attributes is done through interpolation from the values of the attributes at the vertices. The setup block computes the derivatives of the attributes with respect to x and y directions and the rasterizer integrates these derivatives starting from the value of the attributes at the starting point and computes the value of the attributes at the sample locations or pixel center locations as required.

Interpolation along a scan line, starting from one edge of the triangle and ending at another edge of the triangle, can be obtained either in an integral way, by adding the value of the attribute at the place where the scan line intersects the edge of the triangle to the product obtained multiplying the distance, from the place at which the scan line intersected the edge of the triangle to the location of the particular pixel under consideration, by the slope of the attribute along the scan line, or in an incremental way, by adding the increment of the attributes along the distance between two adjacent pixels, to the value of the attribute at the previous pixel along the scan line.

These two mechanisms present advantages and disadvantages.

The integral method requires a multiplication which needs to be performed by a multiplier which is a complex operator. The incremental method can be done using adders, however this has the disadvantage that the attribute at a pixel location needs to be computed before the attribute at the next pixel location can be computed, and rounding errors get accumulated from pixel to pixel.

A method that takes advantage of the incremental algorithm and reduces the negative effect of the incremental algorithm is a method that combines both techniques. Pixels along the scan line can be organized in groups, providing a course resolution, at group boundary, and a fine resolution, at each pixel location within the group.

By breaking the interpolation down into course resolution interpolation and fine resolution interpolation, we can compute the interpolated values of the attributes at group boundaries using the integral method, and the interpolated values at pixel or sample locations within the group using the incremental method.

Since the number of groups is smaller than the number of pixels, by computing the value of the attributes using the integral method, which requires a multiplier, only for the course resolution, and computing the value of the attributes at pixel locations within the group using the incremental method, which requires adders, it allows us to achieve a design that is more efficient than that which we would have obtained by using only the integral method because we have to perform fewer multiplications, and more precise than that which we would have obtained by using only the incremental method.

If a combination of course resolution interpolation and fine resolution interpolation is used, at each scanning step the scanner increments several samples at a time.

The z attributes need to be com[uted before performing the occlusion test.

### Occlusion Test

Samples that pass the triangle belonging test can be used to perform an occlusion test, to see if some other triangles prevent these samples from being visible. Occlusion test is done by comparing the depth value of the each samples of the triangle with the depth value that is stored inside the depth buffer, using an appropriate comparison function to determine if a sample is visible or not.

The method can be used whether each pixel contains a single sampling point, or multiple sampling points as in the case of multisampling or supersampling.

If supersampling is used, all the attributes are computed for each sample and the shader program will be applied to each sample.

If multisampling is used, only the depth attribute is computed for each sample, and the other attributes are computed only for the center of the pixel, and the shader program is applied only to the center of the pixel.

Subsequent filtering allows to obtain an image with reduced aliasing effect.

In certain situations determination of whether the scanning has exited the triangle can be done by comparing the position of only some of the samples with the line in which direction the scanning is taking place.

While scanning in a certain direction we need to compute the distance from the line that is in front of the direction of scanning. That distance gets computed incrementally at every step. When the sign of this distance changed it means the we have crossed the triangle boundary and we need to move to an adjacent row and change the direction of the scan.

### Computation of the Other Attributes

The remaining attributes are computed only for those pixels which contain at least one sample that has passed the belonging test and the occlusion test.

The remaining attributes are computed only at the center of the pixels. In a preferred implementation pixels can be grouped in a group of 2×2. Integral computation and course resolution can also be used here for the block of pixels and incremental computation and fine resolution can also be used here for the center of the pixels within each block.

I claim:

1. A method and apparatus for implementing a restartable FIFO which allows to read the data from the FIFO from a predetermined point multiple times, by having the following state information besides the conventional read and write pointer: base register, repeating register, end-of-the-run register; and two additional control bits new-run and rerun, such that when the signal new-run is active the base register receives the value of the read pointer; when the signal rerun is active the read pointer receives the value of the base register, the end-of-the-run register receives the value of the read pointer and the repeating register is set to a 1; when the read pointer reaches the value contained in the end-of-the-run register the repeating register is cleared to 0. When the repeating register is not set the full signal is generated when the write pointer reaches the value contained in read pointer register; when the repeating register is set, the full signal is generated when the write pointer reaches value contained in the end-of-the-run register.

2. Method and apparatus for performing triangle assembly using restartable FFOs described in claim 2 to hold the value of vertices that are shared among multiple triangle.

3. Method and apparatus for performing clipping using restartable FIFOs described in claim 2 to generate interpolated values of triangle attributes along edges, of the triangle, that share the same vertex.

4. Method and apparatus to implement a triangle rasterizer using restartable FIFOs described in claim 2, by performing computation of pixel attributes at each pixel of a triangle, using the precomputed value for parameters that are common for the whole triangle, by storing them inside a restartable FIFO and reutilizing them for every pixel.

5. Method and apparatus for performing the triangle belonging test, by using one or more sampling points simultaneously that may belong to one pixel or to a group of pixels and a scanning algorithm that reverses direction once it reaches the edge of a triangle and by computing the distance from each sampling point in the group of sampling points, to the triangle edge towards which the scanning is moving and by computing the distance from the same sampling points to the triangle edge from which the scanning is moving away, in an incremental way, starting from the value of the distance from a starting point to the triangle edge towards which the scanning is moving and from the value the distance from the starting point to the triangle edge from which the scanning is moving away, and updating these distances as scanning moves to an adjacent group of samples by adding a precomputed value to these distances, where the precomputed value can represent the increment of the distance in the horizontal direction in the vertical direction, and by determining the condition of belonging to the triangle only by analyzing the distance, in the horizontal direction or in the vertical direction, from sampling points being considered to the edge of the triangle towards which the scanning is moving.

6. Method for performing the interpolation of attributes of the vertices of a triangle in hardware, by breaking down the interpolation into an interpolation with coarse spatial resolution and an interpolation with fine spatial resolution.

7. Method of finding the a starting point for rasterizing a triangle, by using clipping window dividers, where such clipping window dividers provide additional lines within the clipping window, to guarantee that an edge of the triangle intersects at least a clipping window edge or a clipping window divider with an incident angle greater that 45°, so that these additional lines can be used to find the starting point of rasterization as the intersection of one of the edges of the triangle with one of such lines or with an edge of the clipping window, by using an equation for the edge of the triangle that permits the computation of the intersection point with a clipping window divider line or with an edge of the clipping window without having to invert the angular coefficient m or 1/m of the line equation of the edge of the triangle.
